(19) United States
(12) Patent Application Publication
(10) Pub. No.: US 2020/0095485 A1
(43) Pub. Date: Mar. 26, 2020

(54) ADHESIVE COMPOSITION, COMPONENT, AND METHOD OF FORMING THE COMPONENT

(71) Applicants: GM GLOBAL TECHNOLOGY OPERATIONS LLC, Detroit, MI (US); Zhengzhou University, Zhengzhou City, Henan (CN)

(72) Inventors: Pei-chung Wang, Troy, MI (US); Hua-tzu Fan, Troy, MI (US); Bin Cai, Zhengzhou City (CN); Zhongxia Liu, Zhengzhou City (CN)

(73) Assignees: GM GLOBAL TECHNOLOGY OPERATIONS LLC, Detroit, MI (US); Zhengzhou University, Zhengzhou City, Henan (CN)

(21) Appl. No.: 16/469,405

(22) PCT Filed: Jan. 16, 2017
(86) PCT No.: PCT/CN2017/071230

§ 371 Date: Jun. 13, 2019

(51) Int. Cl. C09J 163/00; C08G 59/56; C08G 59/24; C08G 59/22; C09J 5/06; C09J 11/04; C09J 11/06; B29C 65/48; B29C 65/00

(52) U.S. Cl. CPC C09J 163/00; C08G 59/56; C08G 59/245; C08G 59/226; B29C 66/1122; C09J 11/04; C09J 11/06; B29C 65/4835; C09J 5/06

(57) ABSTRACT

An adhesive composition includes an epoxy component and an additive component reactive with the epoxy component. The additive component includes an imidazole present in an amount of less than or equal to 10 parts by weight based on 100 parts by weight of the adhesive composition, and an amine present in an amount of less than or equal to 5 parts by weight based on 100 parts by weight of the adhesive composition. The epoxy component and the additive component are present in the adhesive composition in a ratio of from 1:1 to 15:1. A method of forming a component includes curing the adhesive composition at a temperature of less than or equal to 150° C. for less than or equal to 30 minutes to thereby join the first substrate and the second substrate.

### INTRODUCTION

The present disclosure generally relates to an adhesive composition for forming a component that includes two substrates.

An adhesive composition may be used to bind or join one substrate to another. One example of an adhesive composition may be curable upon exposure to heat and may be classified as a two-component (2K) adhesive. That is, a first component of the adhesive composition may react with a second component of the adhesive composition during cure to adhere the one substrate to another.

### SUMMARY

An adhesive composition includes an epoxy component and an additive component reactive with the epoxy component. The additive component includes an imidazole present in an amount of less than or equal to 10 parts by weight based on 100 parts by weight of the adhesive composition, and an amine present in an amount of less than or equal to 5 parts by weight based on 100 parts by weight of the adhesive composition. The epoxy component and the additive component are present in the adhesive composition in a ratio of from 1:1 to 15:1.

The imidazole may have a number average molecular weight of less than or equal to 115 g/mol. Further, the imidazole may have a melting point of from 36° C. to 42° C. In one example, the imidazole may be 2-Ethyl-4-methylimidazole.

In one aspect, the imidazole may be present in the adhesive composition in an amount of from 2 parts by weight to 6 parts by weight based on 100 parts by weight of the adhesive composition. In another aspect, the imidazole may be present in the adhesive composition in an amount of from 3 parts by weight to 5 parts by weight based on 100 parts by weight of the adhesive composition.

The amine may have a number average molecular weight of less than or equal to 120 g/mol. Further, the amine may have a melting point of from −30° C. to −25° C. In one aspect, the amine is N-(2-Hydroxyethyl)ethylenediamene.

In one aspect, the amine may be present in the adhesive composition in an amount of from 1 part by weight to 4 parts by weight based on 100 parts by weight of the adhesive composition. In another aspect, the amine may be present in the adhesive composition in an amount of from 2 parts by weight to 3 parts by weight based on 100 parts by weight of the adhesive composition.

The epoxy component may include a heat-curable epoxy resin. In one aspect, the epoxy component may include epichlorohydrin-4,4′-isopropylidene diphenol resin present in an amount of from 30 parts by weight to 60 parts by weight based on 100 parts by weight of the epoxy component; bisphenol A diglycidyl ether resin present in an amount of from 10 parts by weight to 30 parts by weight based on 100 parts by weight of the epoxy component; fumed silica present in an amount of from 1 part by weight to 5 parts by weight based on 100 parts by weight of the epoxy component; tris(methylphenyl) phosphate present in an amount of from 1 part by weight to 5 parts by weight based on 100 parts by weight of the epoxy component; and calcium oxide present in an amount of from 1 part by weight to 5 parts by weight based on 100 parts by weight of the epoxy component.

A component includes a first substrate formed from a first material and a second substrate formed from a second material. The second substrate overlaps and is adhered to the first substrate at a bond area. The component also includes a cured adhesive formed from the adhesive composition and disposed between and in contact with the first substrate and the second substrate at the bond area.

In one aspect, the first material is different from the second material. As such, the first material may have a first coefficient of thermal expansion and the second material may have a second coefficient of thermal expansion that is less than the first coefficient of thermal expansion. In another aspect, the first material may be the same as the second material. Further, the first material and the second material may be free from distortion at the bond area.

For the adhesive composition, in one aspect, the amine may be N-(2-Hydroxyethyl)ethylenediamene and may be present in an amount of from 1 part by weight to 3 parts by weight based on 100 parts by weight of the adhesive composition; and the imidazole may be 2-Ethyl-4-methylimidazole and may be present in an amount of from 3 parts by weight to 5 parts by weight based on 100 parts by weight of the adhesive composition.

A method of forming a component includes applying the adhesive composition to a first substrate at a bond area. The method also includes disposing a second substrate onto the adhesive composition at the bond area, and pressing together the first substrate, the adhesive composition, and the second substrate at the bond area. The method further includes curing the adhesive composition at a temperature of less than or equal to 150° C. for less than or equal to 30 minutes to thereby join the first substrate and the second substrate and form the component.

In one aspect, curing includes heating the adhesive composition at a temperature of less than or equal to 130° C. for less than or equal to 20 minutes.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic illustration of a side view of a component including a first substrate adhered to a second substrate with a cured adhesive.

FIG. 2 is a schematic flowchart of a method of forming the component of FIG. 1.

FIG. 3 is a graphical representation of a representative relationship between various curing temperatures of the cured adhesive of FIG. 1 and various peak loads imparted to the component of FIG. 1 as compared to a comparative cured adhesive.

FIG. 4 is a graphical representation of a representative relationship between various curing temperatures of the cured adhesive of FIG. 1 and various peak loads imparted to another example of the component of FIG. 1 as compared to a comparative cured adhesive.

FIG. 5 is a graphical representation of a joint strength of the cured adhesive of FIG. 1 as compared to a comparative cured adhesive as measured at ambient temperature for three examples of the component of FIG. 1.

FIG. 6 is a graphical representation of a joint strength of the cured adhesive of FIG. 1 as compared to a comparative cured adhesive as measured at 82° C. for three examples of the component of FIG. 1.

### DETAILED DESCRIPTION

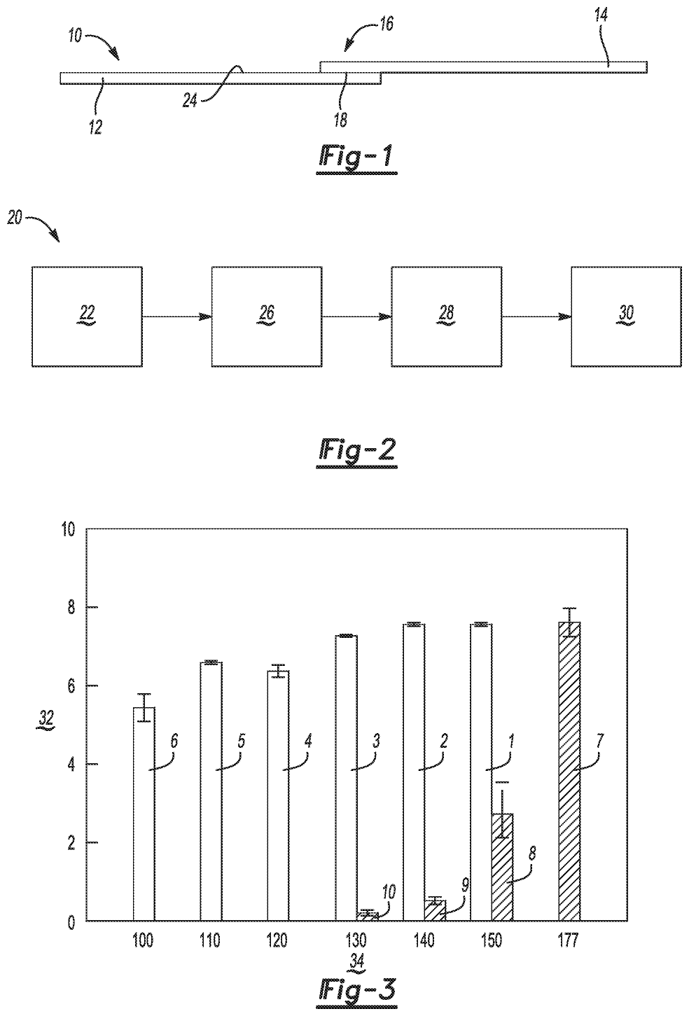

Referring to the Figures, wherein like reference numerals refer to like elements, a component 10 is shown generally in FIG. 1. The component 10 may be useful for automotive applications, such as a composite panel formed from two substrates. However, the component 10 may also be useful for non-automotive applications, such as appliances, high-torque machinery, cabinetry, structural components, and the like for residential, industrial, aviation, rail, and commercial applications.

By way of general explanation and described with reference to FIG. 1, the component 10 includes a first substrate 12 formed from a first material and a second substrate 14 formed from a second material. The first material may be the same as the second material, or the first material may be different from the second material. For the configuration in which the first material is different from the second material, the first material may have a first coefficient of thermal expansion and the second material may have a second coefficient of thermal expansion that is less than the first coefficient of thermal expansion.

For example, one or both of the first material and the second material may be, as non-limiting examples, a metal, such as aluminum or steel; a plastic, such as a polyurethane; or a composite, such as a carbon-fiber composite. One example of a carbon-fiber composite may include 30 parts by weight carbon fiber and 70 parts by weight nylon-6 based on 100 parts by weight of the carbon-fiber composite. Therefore, in one non-limiting example, the first material may be aluminum and the second material may be the carbon-fiber composite. In another non-limiting example, the first material may be aluminum and the second material may be steel. In a further non-limiting example, the first material and the second material may be aluminum.

Referring again to FIG. 1, the second substrate 14 is overlapping and adhered to the first substrate 12 at a bond area 16. Although dependent upon substrate 12, 14 selection, in one non-limiting example, the first substrate 12 may have a length of about 100 mm, a width of about 25 mm, and a thickness of about 2 mm; the second substrate 14 may have a length of about 135 mm, a width of about 40 mm, and a thickness of about 2.5 mm; and the bond area 16 may have a length of about 15 mm.

The component 10 also includes a cured adhesive 18 formed from an adhesive composition and disposed between and in contact with the first substrate 12 and the second substrate 14 at the bond area 16. That is, the adhesive composition is cured to form the cured adhesive 18, and the cured adhesive 18 adheres and joins the first substrate 12 and the second substrate 14 to one another.

More specifically, the adhesive composition includes an epoxy component and an additive component reactive with the epoxy component. That is, the adhesive composition may be characterized as a two-component (2K) adhesive composition.

The epoxy component may include a heat-curable epoxy resin, i.e., one or more reactive prepolymers and polymers having an epoxide group. The epoxy resin may be crosslinkable with the additive component as set forth in more detail below. That is, the adhesive composition may be cured via heating to form the cured adhesive. In one non-limiting example, the epoxy component may include epichlorohydrin-4,4′-isopropylidene diphenol resin present in an amount of from 30 parts by weight to 60 parts by weight based on 100 parts by weight of the epoxy component; bisphenol A diglycidyl ether resin present in an amount of from 10 parts by weight to 30 parts by weight based on 100 parts by weight of the epoxy component; fumed silica present in an amount of from 1 part by weight to 5 parts by weight based on 100 parts by weight of the epoxy component; tris(methylphenyl) phosphate present in an amount of from 1 part by weight to 5 parts by weight based on 100 parts by weight of the epoxy component; and calcium oxide present in an amount of from 1 part by weight to 5 parts by weight based on 100 parts by weight of the epoxy component. A non-limiting example of the epoxy component is commercially available under the tradename Terokal® 5089 from Henkel Corporation of Rocky Hill, Conn.

The adhesive composition also includes an additive component reactive with the epoxy component. That is, the additive composition may be a co-reactant of the epoxy component during a curing or crosslinking reaction and may be characterized as a curative. The epoxy component and the additive component may be kept separate from one another until the cured adhesive is desired. Further, the epoxy component and the additive component may be present in the adhesive composition in a ratio of from 1:1 to 15:1. That is, in one non-limiting example, the adhesive composition may include substantially equal parts of the epoxy component and the additive component. For this example, the adhesive composition may also include a filler component that includes one or more fillers to reduce the ratio of epoxy component to additive component to about 1:1. In another non-limiting example, the adhesive composition may include more of the epoxy component than the additive component, e.g., about 15 times or about 10 times or about 5 times more of the epoxy component. At a ratio of less than about 1:1 or at greater than about 15:1, the adhesive composition may not cure effectively or the cured adhesive may not maintain adhesion between the first substrate 12 and the second substrate 14.

More specifically, the additive component includes an imidazole present in an amount of less than or equal to 10 parts by weight based on 100 parts by weight of the adhesive composition. For example, the imidazole may be present in the adhesive composition in an amount of from 2 parts by weight to 6 parts by weight based on 100 parts by weight of the adhesive composition. In another non-limiting example, the imidazole may be present in the adhesive composition in an amount of from 3 parts by weight to 5 parts by weight, e.g., 4 parts by weight, based on 100 parts by weight of the adhesive composition. At amounts of greater than 10 parts by weight of imidazole, the adhesive composition may require comparatively long cure times and/or temperatures. In addition, at amounts of greater than 10 parts by weight of imidazole, the adhesive composition may not sufficiently adhere the first substrate 12 and the second substrate 14 to one another for configurations in which the first material is different from the second material.

The imidazole may have a number average molecular weight of less than or equal to 115 g/mol, e.g., about 110 g/mol. Further, the imidazole may have a melting point of from 36° C. to 42° C. In one non-limiting example, the imidazole may be 2-Ethyl-4-methylimidazole and may be present in the adhesive composition in an amount of from 3 parts by weight to 5 parts by weight, e.g., 4 parts by weight, based on 100 parts by weight of the adhesive composition.

The additive component also includes an amine present in an amount of less than or equal to 5 parts by weight based on 100 parts by weight of the adhesive composition. For example, the amine may be present in the adhesive composition in an amount of from 1 part by weight to 4 parts by weight based on 100 parts by weight of the adhesive composition. In another non-limiting example, the amine may be present in the adhesive composition in an amount of from 2 parts by weight to 3 parts by weight, e.g., 2.5 parts by weight, based on 100 parts by weight of the adhesive composition. At amounts of greater than 5 parts by weight of amine, the adhesive composition may require comparatively long cure times and/or temperatures. In addition, at amounts of greater than 5 parts by weight of amine, the adhesive composition may not sufficiently adhere the first substrate 12 and the second substrate 14 to one another for configurations in which the first material is different from the second material.

The amine may have a number average molecular weight of less than or equal to 120 g/mol, e.g., about 105 g/mol. Further, the amine may have a melting point of from −30° C. to −25° C. In one non-limiting example, the amine may be N-(2-Hydroxyethyl)ethylenediamine and may be present in the adhesive composition in an amount of from 1 part by weight to 3 parts by weight, e.g., 2.5 parts by weight, based on 100 parts by weight of the adhesive composition.

Referring again to FIG. 1, once the adhesive composition is cured to form the cured adhesive as set forth in more detail below, the first material and the second material may be free from distortion at the bond area 16. That is, even for configurations in which the first material differs from the second material such that the first coefficient of thermal expansion is different from the second coefficient of thermal expansion, the bond area 16 may not be distorted when the component 10 is viewed from above. The adhesive composition therefore reduces thermal distortion and residual thermal stress in the first substrate 12 and the second substrate 14 during curing of the adhesive composition such that the component 10 has excellent dimensional stability.

Referring now to FIG. 2, a method 20 of forming the component includes applying 22 the adhesive composition to the first substrate 12 at the bond area 16. The adhesive composition may be applied to the first substrate 12 in any suitable manner. For example, applying 22 may include brushing, dipping, spraying, roll coating, dispensing, injecting, or the like onto the first substrate 12 at the bond area 16. Applying 22 may coat the first substrate 12 with the adhesive composition on at least one surface 24 of the first substrate at at least the bond area 16.

The method 20 also includes disposing 26 the second substrate 14 onto the adhesive composition at the bond area 16. That is, disposing 26 may include placing the second substrate 14 onto the first substrate 12 at the bond area 16. In addition, disposing 26 may include aligning the second substrate 14 with the first substrate 12.

Further, the method 20 includes pressing 28 together the first substrate 12, the adhesive composition, and the second substrate 14 at the bond area 16 to form a workpiece. Pressing 28 may include any suitable manner of forcefully contacting the first substrate 12, the adhesive composition, and the second substrate 14. For example, the first substrate 12, the adhesive composition, and the second substrate 14 may be pressed together in a fixture that applies pressure to the workpiece. Pressing 28 together may establish a bondline thickness at the bond area 16 of from 0.05 mm to 1.25 mm. Generally, a comparatively thinner bondline thickness, e.g., about 0.5 mm, may be desired since a stress concentration at a corner of the bond area 16 may be reduced for comparatively thinner bondline thicknesses and may optimize shear and tensile strength properties.

Referring again to FIG. 2, the method 20 also includes curing 30 the adhesive composition at a temperature of less than or equal to 150° C. for less than or equal to 30 minutes to thereby join the first substrate 12 and the second substrate 14. For example, curing 30 may include heating the adhesive composition at a temperature of less than or equal to 130° C. for less than or equal to 20 minutes. Alternatively, curing 30 may include heating the adhesive composition at a temperature of 140° C. or 120° C. or 110° C. or 100° C. for 25 minutes or 15 minutes or 10 minutes. Curing 30 may include adhering or bonding or joining the first substrate 12 and the second substrate 14 together by heating the adhesive composition at a comparatively low temperature, e.g., less than or equal to 130° C., for a comparatively short duration, e.g., less than or equal to 20 minutes, even when the first material and the second material are different from one another.

As such, the method 20 and the adhesive composition allow metal to be adhered to a polymeric material and cured once. That is, the metal and the polymeric material may be adhered to one another under the same conditions. In addition, the method 20 and the adhesive composition allow for reduced curing temperatures and durations, which in turn reduces cost and improves efficiency for assembly processes and applications requiring durable components 10. Specifically, for applications requiring components 10 formed from a metal adhered to a polymer or composite, previously separate curing facilities may be combined into one curing facility. Similarly, lower oven bake or curing temperatures and/or shorter bake or curing times may reduce energy consumption and bake oven length. Further, as set forth above, the method 20 and the adhesive composition allow for excellent adherence between the first substrate 12 and the second substrate 14 without thermal distortion and minimized residual thermal stress for excellent dimensional stability of the component 10. As such, the components 10 formed by the method 20 are useful for applications requiring components 10 having minimal distortion, excellent adhesion strength, and economical processing. The method 20 and the adhesive composition combine the advantages of low cure temperature, short cure duration, and excellent joint strength, even for applications requiring strong joint adhesion at warm ambient temperatures of 82° C.

The following examples are meant to illustrate the disclosure and are not to be viewed in any way as limiting to the scope of the disclosure.

### EXAMPLES

Aluminum—Aluminum Components

To prepare the adhesive composition of Examples 1-6 and Comparative Examples 7-10, materials A, B, and C are combined in the amounts listed in Table 1.

TABLE 1
Adhesive Compositions

| | | | Mate- | Mate- | Mate- |
|---|---|---|---|---|---|
| | First | Second | rial A | rial B | rial C |
| Sample | Substrate | Substrate | (wt %) | (wt %) | (wt %) |
| Ex. 1 | AA6061 | AA6061 | 93.5 | 4 | 2.5 |
| | aluminum | aluminum | | | |
| Ex. 2 | AA6061 | AA6061 | 93.5 | 4 | 2.5 |
| | aluminum | aluminum | | | |
| Ex. 3 | AA6061 | AA6061 | 93.5 | 4 | 2.5 |
| | aluminum | aluminum | | | |
| Ex. 4 | AA6061 | AA6061 | 93.5 | 4 | 2.5 |
| | aluminum | aluminum | | | |
| Ex. 5 | AA6061 | AA6061 | 93.5 | 4 | 2.5 |
| | aluminum | aluminum | | | |
| Ex. 6 | AA6061 | AA6061 | 93.5 | 4 | 2.5 |
| | aluminum | aluminum | | | |
| Comp. Ex. 7 | AA6061 | AA6061 | 100 | — | — |
| | aluminum | aluminum | | | |
| Comp. Ex. 8 | AA6061 | AA6061 | 100 | — | — |
| | aluminum | aluminum | | | |
| Comp. Ex. 9 | AA6061 | AA6061 | 100 | — | — |
| | aluminum | aluminum | | | |
| Comp. Ex. 10 | AA6061 | AA6061 | 100 | — | — |
| | aluminum | aluminum | | | |

Component A is a one-component (1K) epoxy adhesive commercially available under the trade name Terokal® 5089 from Henkel Corporation of Rocky Hill, Conn.

Component B is 2-Ethyl-4-methylimidazole (2,4-EMI) commercially available from Sigma Aldrich Corp. of St. Louis, Mo.

Component C is N-(2-Hydroxyethyl)ethylenediamine (AEEA) commercially available from Sigma Aldrich Corp. of St. Louis, Mo.

To prepare the components of Examples 1-6 and Comparative Examples 7-10, a first plurality of substrates each formed from aluminum AA6061 and having a thickness of 2 mm, a width of 25 mm, and a length of 100 mm are provided. A second plurality of substrates each formed from aluminum AA6061 and having a thickness of 2 mm, a width of 25 mm, and a length of 100 mm are provided.

Each of the first plurality of substrates and the second plurality of substrates is pretreated according to the following process to remove any contaminants and/or oxides present on each of the first plurality of substrates and the second plurality of substrates. Initially, each of the first plurality of substrates and each of the second plurality of substrates is degreased with acetone for 2 minutes in an ultrasonic cleaner to produce a plurality of degreased first substrates and a plurality of degreased second substrates. Second, each of the plurality of degreased first substrates and each of the plurality of degreased second substrates is abraded with an 800# abrasive fabric to produce a plurality of abraded first substrates and a plurality of abraded second substrates. Next, each of the plurality of abraded first substrates and each of the plurality of abraded second substrates is rinsed with alcohol for 2 minutes in the ultrasonic cleaner to produce a plurality of rinsed first substrates and a plurality of rinsed second substrates. Then, each of the plurality of rinsed first substrates and each of the plurality of rinsed second substrates is immersed for 2 minutes at 70° C. in a solution of 18.54 g of Na₃PO₄.12H₂O, 6.98 g of Na₂SiO₃.9H₂O, 3.0 g of Na₂CO₃, 0.3 g of C₁₈H₂₉SO₃Na, 2.0 g of NaOH, and 200 ml of de-ionized water. After immersing the plurality of rinsed first substrates and the plurality of rinsed second substrates in solution, each of the plurality of rinsed first substrates and each of the plurality of rinsed second substrates is again rinsed thoroughly with de-ionized water for 2 minutes in the ultrasonic cleaner. Next, each of the plurality of rinsed first substrates and each of the plurality of rinsed second substrates is dried for 30 minutes at 100° C. to form a plurality of first substrates and a plurality of second substrates.

To prepare the components of Examples 1-6 and Comparative Examples 7-10, a respective one of the adhesive compositions of Examples 1-6 and Comparative Examples 7-10 is applied to a respective one of the plurality of first substrates with a hand-held injection gun along a bond area at one end of the first substrate. The bond area has a width of 25 mm and a length of 12.5 mm. To avoid the effect of the environment on the surface of each of the plurality of first substrates, the plurality of first substrates are stored in an ambient laboratory environment of 20° C. and 50% relative humidity before the respective one of the adhesive compositions of Examples 1-6 and Comparative Examples 7-10 is applied.

Next, a respective one of the plurality of second substrates is disposed on top of the respective one of the plurality of adhesive compositions of Examples 1-6 and Comparative Examples 7-10 at the bond area so that the respective second substrate overlaps the respective first substrate by 12.5 mm to form a plurality of workpieces. The plurality of workpieces are disposed in a fixture under ambient laboratory conditions. Pressure is applied to the plurality of workpieces through the fixture so that a bondline thickness of the respective adhesive composition is 0.2 mm. Then, each of the plurality of workpieces is cured in an oven for 20 minutes at the curing temperatures 34 (FIG. 3) listed in Table 2.

TABLE 2
Curing Temperatures

| Sample | Curing Temperature (° C.) |
|---|---|
| Ex. 1 | 150 |
| Ex. 2 | 140 |
| Ex. 3 | 130 |
| Ex. 4 | 120 |
| Ex. 5 | 110 |
| Ex. 6 | 100 |
| Comp. Ex. 7 | 177 |
| Comp. Ex. 8 | 150 |
| Comp. Ex. 9 | 140 |
| Comp. Ex. 10 | 130 |

Quasi-static testing is performed on each the components of Examples 1-6 and Comparative Examples 7-10 by loading each component to failure in a MTS810 tensile tester according to the standard ASTM D1002-2001 to determine a joint strength of each of the components. To minimize the bending stresses inherent in such testing, one filler plate is attached to the respective first substrate of the respective component with masking tape at an end spaced opposite from the bond area, and another filler plate is attached to the respective second substrate with masking tape at an end spaced opposite from the bond area. Load versus displacement curves are generated as each of the plurality of components is loaded at a stroke rate of 10 mm/minute, and a peak load in each load versus displacement curve is used to evaluate the joint strength of the each respective component. Joint strength is defined as a ratio of peak load 32 (FIG. 3) to an area of the bond area, i.e., 312.5 mm². Three replicates of the above-described quasi-static testing are performed and an average peak load 32 for each of the plurality of components of Examples 1-6 and Comparative Examples 7-10 is shown graphically in FIG. 3. A component that has a joint strength corresponding to a peak load 32 of greater than or equal to 5 kN is acceptable and passes the above-described quasi-static testing as summarized in Table 3.

TABLE 3
Quasi-Static Testing Results

| Sample | Test Result |
|---|---|
| Ex. 1 | Acceptable - Pass |
| Ex. 2 | Acceptable - Pass |
| Ex. 3 | Acceptable - Pass |
| Ex. 4 | Acceptable - Pass |
| Ex. 5 | Acceptable - Pass |
| Ex. 6 | Acceptable - Pass |
| Comp. Ex. 7 | Acceptable - Pass |
| Comp. Ex. 8 | Not acceptable - Fail |
| Comp. Ex. 9 | Not acceptable - Fail |
| Comp. Ex. 10 | Not acceptable - Fail |

Referring now to FIG. 3 and Table 3, each of the components of Examples 1-6 and Comparative Example 7 has an acceptable joint strength, i.e., a peak load 32 of greater than 5 kN. In contrast, each of the components of Comparative Examples 8-10 do not have an acceptable joint strength. Notably, the curing temperature 34 of Examples 1-6 is from 22° C. to 77° C. lower than the curing temperature 34 of Comparative Example 7, and the adhesive compositions of Examples 1-6 include materials B and C, i.e., 2-Ethyl-4-methylimidazole (2,4-EMI) and N-(2-Hydroxyethyl)ethylenediamine (AEEA). Therefore, the adhesive compositions of Examples 1-6 may be cured at a lower temperature than the adhesive composition of Comparative Example 7 and still have an acceptable joint strength. By comparison, the adhesive compositions of Comparative Examples 8-10 do not have an acceptable joint strength after cure at the same temperatures as Examples 1, 2, and 3, respectively. That is, the adhesive compositions of Comparative Examples 8-10 do not include materials B and C and therefore must be cured at a higher curing temperature 34. Therefore, excellent joint strength for components that include two sheets of aluminum adhered to one another and lower curing temperature 34 for the adhesive composition may be obtained by adding materials B and C to material A.

Polymeric Composite—Polymeric Composite Components

To prepare the adhesive composition of Examples 11 and 12 and Comparative Examples 13-15, materials A, B, and C are combined in the amounts listed in Table 4. As used herein, the nomenclature C_{f}/PA6 refers to a polymeric composite of carbon fiber and nylon-6.

TABLE 4
Adhesive Compositions

| | | | Mate- | Mate- | Mate- |
|---|---|---|---|---|---|
| | First | Second | rial A | rial B | rial C |
| Sample | Substrate | Substrate | (wt %) | (wt %) | (wt %) |
| Ex. 11 | C_{f}/PA6 | C_{f}/PA6 | 93.5 | 4 | 2.5 |
| Ex. 12 | C_{f}/PA6 | C_{f}/PA6 | 93.5 | 4 | 2.5 |
| Comp. Ex. 13 | C_{f}/PA6 | C_{f}/PA6 | 100 | — | — |
| Comp. Ex. 14 | C_{f}/PA6 | C_{f}/PA6 | 100 | — | — |
| Comp. Ex. 15 | C_{f}/PA6 | C_{f}/PA6 | 100 | — | — |

To prepare the components of Examples 11 and 12 and Comparative Examples 13-15, a plurality of first substrates each formed from the polymeric composite including 30 parts by weight carbon fiber and 70 parts by weight nylon-6 and having a thickness of 2.3 mm, a width of 38 mm, and a length of 133 mm are provided.

A plurality of second substrates each formed from the polymeric composite including 30 parts by weight carbon fiber and 70 parts by weight nylon-6 and having a thickness of 2.3 mm, a width of 38 mm, and a length of 133 mm are provided.

To prepare the components of Examples 11 and 12 and Comparative Examples 13-15, a respective one of the adhesive compositions of Examples 11 and 12 and Comparative Examples 13-15 is applied to a respective one of the plurality of first substrates with a hand-held injection gun along a bond area at one end of the first substrate. The bond area has a width of 38 mm and a length of 15 mm. To avoid the effect of the environment on the surface of each of the plurality of first substrates, the plurality of first substrates are stored in an ambient laboratory environment of 20° C. and 50% relative humidity before each of the adhesive compositions of Examples 11 and 12 and Comparative Examples 13-15 is applied.

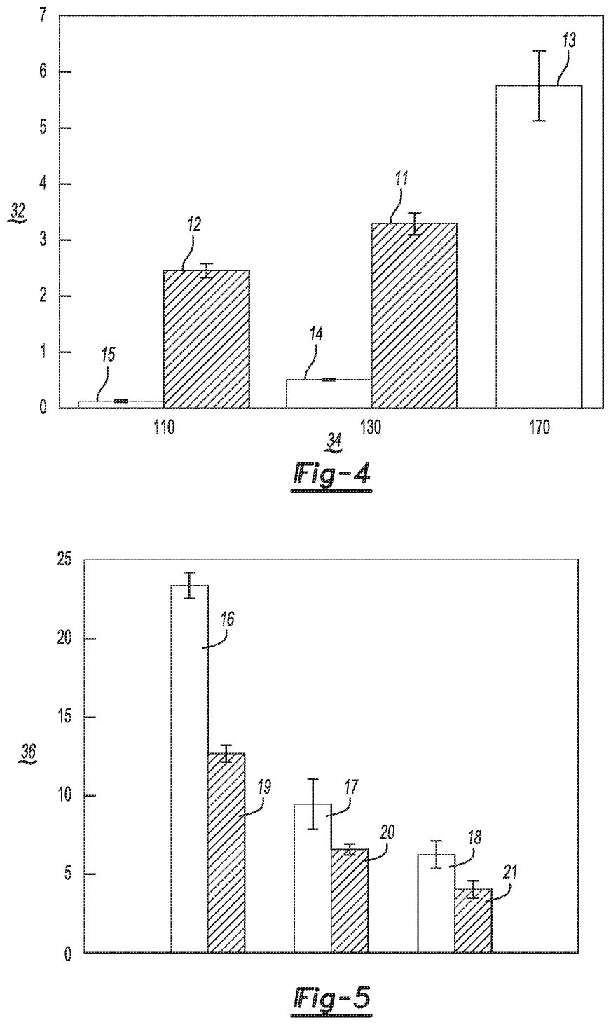

Next, a respective one of the plurality of second substrates is disposed on top of the respective one of the plurality of adhesive compositions of Examples 11 and 12 and Comparative Examples 13-15 at the bond area so that the respective second substrate overlaps the respective first substrate by 15 mm to form a plurality of workpieces. The plurality of workpieces are disposed in a fixture under ambient laboratory conditions. Pressure is applied to the plurality of workpieces through the fixture so that a bondline thickness of the respective adhesive composition is 0.2 mm. Then, each of the plurality of workpieces is cured in an oven for 20 minutes at the curing temperatures 34 (FIG. 4) listed in Table 5.

TABLE 5
Curing Temperatures

| Sample | Curing Temperature (° C.) |
|---|---|
| Ex. 11 | 130 |
| Ex. 12 | 110 |
| Comp. Ex. 13 | 170 |
| Comp. Ex. 14 | 130 |
| Comp. Ex. 15 | 110 |

Quasi-static testing is performed on each the components of Examples 11 and 12 and Comparative Examples 13-15 by loading each of the respective components to failure in a MTS810 tensile tester according to the standard ASTM D1002-2001 to determine a joint strength of each of the components. To minimize the bending stresses inherent in such testing, one filler plate is attached to the first substrate of the respective component with masking tape at an end spaced opposite from the bond area, and another filler plate is attached to the second substrate with masking tape at an end spaced opposite from the bond area. Load versus displacement curves are generated as each of the plurality of components is loaded at a stroke rate of 10 mm/minute, and a peak load in each load versus displacement curve is used to evaluate the joint strength of each component. Joint strength is defined as a ratio of peak load 32 (FIG. 4) to an area of the bond area, i.e., 570 mm². Three replicates of the above-described quasi-static testing are performed and an average joint strength for each of the plurality of components of Examples 11 and 12 and Comparative Examples 13-15 is shown graphically in FIG. 4. A component that has a joint strength corresponding to a peak load 32 of greater than or equal to 2 kN is acceptable and passes the above-described quasi-static testing as summarized in Table 6.

TABLE 6
Quasi-Static Testing Results

| Sample | Test Result |
|---|---|
| Ex. 11 | Acceptable - Pass |
| Ex. 12 | Acceptable - Pass |
| Comp. Ex. 13 | Acceptable - Pass |
| Comp. Ex. 14 | Not acceptable - Fail |
| Comp. Ex. 15 | Not acceptable - Fail |

Referring now to FIG. 4 and Table 6, each of the components of Examples 11 and 12 and Comparative Example 13 has an acceptable joint strength, i.e., a peak load 32 greater than 2 kN. In contrast, each of the components of Comparative Examples 14 and 15 do not have an acceptable joint strength. Notably, the curing temperature 34 of Examples 11 and 12 is from 40° C. to 60° C. lower than the curing temperature 34 of Comparative Example 13, and the adhesive compositions of Examples 11 and 12 include materials B and C, i.e., 2-Ethyl-4-methylimidazole (2,4-EMI) and N-(2-Hydroxyethyl)ethylenediamine (AEEA). Therefore, the adhesive compositions of Examples 11 and 12 may be cured at a lower temperature than the adhesive composition of Comparative Example 13 and still have an acceptable joint strength. By comparison, the adhesive compositions of Comparative Examples 14 and 15 do not have an acceptable joint strength after cure at the same temperatures as Examples 11 and 12, respectively. That is, the adhesive compositions of Comparative Examples 14 and 15 do not include materials B and C and therefore must be cured at a higher curing temperature 34. Therefore, excellent joint strength for components that includes two sheets of polymeric composite adhered to one another and lower curing temperature 34 for the adhesive composition may be obtained by adding materials B and C to material A.

Joint Strength at Ambient Temperature

To prepare the adhesive composition of Examples 16-18, materials A, B, and C are combined in the amounts listed in Table 7.

TABLE 7
Adhesive Compositions

| | | | Mate- | Mate- | Mate- |
|---|---|---|---|---|---|
| | First | Second | rial A | rial B | rial C |
| Sample | Substrate | Substrate | (wt %) | (wt %) | (wt %) |
| Ex. 16 | AA6061 | AA6061 | 93.5 | 4 | 2.5 |
| | aluminum | aluminum | | | |
| Ex. 17 | AA6061 | C_{f}/PA6 | 93.5 | 4 | 2.5 |
| | aluminum | | | | |
| Ex. 18 | C_{f}/PA6 | C_{f}/PA6 | 93.5 | 4 | 2.5 |

The adhesive composition of Comparative Examples 19-21 is a two-component (2K) epoxy adhesive composition commercially available under the trade name Lord® 320 from Lord Corporation of Cary, N.C.

To prepare the components of Example 16 and Comparative Example 19, a plurality of first substrates each formed from aluminum AA6061 and having a thickness of 2 mm, a width of 25 mm, and a length of 100 mm are provided; and a plurality of second substrates formed from aluminum AA6061 and having a thickness of 2 mm, a width of 25 mm, and a length of 100 mm are provided.

To prepare the components of Example 17 and Comparative Example 20, a first plurality of substrates formed from aluminum AA6061 and having a thickness of 2.3 mm, a width of 38 mm, and a length of 133 mm are provided; and a plurality of second substrates each formed from a polymeric composite including 30 parts by weight carbon fiber and 70 parts by weight nylon-6 and having a thickness of 2.3 mm, a width of 38 mm, and a length of 133 mm are provided.

To prepare the components of Example 18 and Comparative Example 21, a plurality of first substrates formed from a polymeric composite including 30 parts by weight carbon fiber and 70 parts by weight nylon-6 and having a thickness of 2.3 mm, a width of 38 mm, and a length of 133 mm are provided; and a plurality of second substrates each formed from a polymeric composite including 30 parts by weight carbon fiber and 70 parts by weight nylon-6 and having a thickness of 2.3 mm, a width of 38 mm, and a length of 133 mm are provided.

Each of the plurality of substrates formed from aluminum is pretreated according to the following process to remove any contaminants and/or oxides present on each of the substrates. Initially, each of the first plurality of substrates is degreased with acetone for 2 minutes in an ultrasonic cleaner to produce a plurality of degreased first substrates. Second, each of the plurality of degreased first substrates is abraded with an 800# abrasive fabric to produce a plurality of abraded first substrates. Next, each of the plurality of abraded first substrates is rinsed with alcohol for 2 minutes in the ultrasonic cleaner to produce a plurality of rinsed first substrates. Then, each of the plurality of rinsed first substrates is immersed for 2 minutes at 70° C. in a solution of 18.54 g of Na₃PO₄.12H₂O, 6.98 g of Na₂SiO₃.9H₂O, 3.0 g of Na₂CO₃, 0.3 g of C₁₈H₂₉SO₃Na, 2.0 g of NaOH, and 200 ml of de-ionized water. After immersing the plurality of rinsed first substrates in solution, each of the plurality of rinsed first substrates is again rinsed thoroughly with de-ionized water for 2 minutes in the ultrasonic cleaner. Next, each of the plurality of rinsed first substrates is dried for 30 minutes at 100° C. to form a plurality of first substrates.

To prepare the components of Examples 16-18 and Comparative Examples 19-21, a respective one of the adhesive compositions of Examples 16-18 and Comparative Examples 19-21 is applied to a respective one of the plurality of first substrates with a hand-held injection gun along a bond area at one end of the first substrate. The bond area has a width of 25 mm and a length of 12.5 mm for Example 16 and Comparative Example 19. The bond area has a width of 38 mm and a length of 15 mm for Examples 17 and 18 and Comparative Examples 20 and 21. To avoid the effect of the environment on the surface of each of the plurality of first substrates, the plurality of first substrates are stored in an ambient laboratory environment of 20° C. and 50% relative humidity before the respective one of the adhesive compositions of Examples 16-18 and Comparative Examples 19-21 is applied.

Next, a respective one of the plurality of second substrates is disposed on top of the respective one of the plurality of adhesive compositions of Example 16 and Comparative Example 19 at the bond area so that the second substrate overlaps the first substrate by 12.5 mm to form a plurality of workpieces. A respective one of the plurality of second substrates is disposed on top of the respective one of the plurality of adhesive compositions of Examples 17 and 18 and Comparative Examples 20 and 21 at the bond area so that the second substrate overlaps the first substrate by 15 mm to form a plurality of workpieces. The plurality of workpieces are disposed in a fixture under ambient laboratory conditions. Pressure is applied to the plurality of workpieces through the fixture so that a bondline thickness of the respective adhesive composition is 0.2 mm. Then, each of the plurality of workpieces is cured in an oven for 120 hours, 72 hours, and 48 hours at ambient temperature for Examples, 16, 17, and 18, respectively.

Quasi-static testing is performed on each the components of Examples 16-18 and Comparative Examples 19-21 by loading each of the respective components to failure in a MTS810 tensile tester according to the standard ASTM D1002-2001 to determine a joint strength 36 (FIG. 5) of each of the components. To minimize the bending stresses inherent in such testing, one filler plate is attached to the first substrate of the respective component with masking tape at an end spaced opposite from the bond area, and another filler plate is attached to the second substrate with masking tape at an end spaced opposite from the bond area. Load versus displacement curves are generated as each of the plurality of components is loaded at a stroke rate of 10 mm/minute, and a peak load in each load versus displacement curve is used to evaluate the joint strength 36 (FIG. 5) of the each respective component at ambient temperature. Joint strength 36 is defined as a ratio of peak load to an area of the bond area, e.g., 312.5 mm² for Example 16 and Comparative Example 19 and 570 mm² for Examples 17 and 18 and Comparative Examples 20 and 21. Three replicates of the above-described quasi-static testing are performed and an average joint strength 36 for each of the plurality of components of Examples 16-18 and Comparative Examples 19-21 is shown graphically in FIG. 5. A component that has a joint strength 36 of greater than or equal to 16 MPa is acceptable for the components of Example 16 and Comparative Example 19 and passes the above-described quasi-static testing as summarized in Table 8. A component that has a joint strength 36 of greater than or equal to 3 MPa is acceptable for the components of Examples 17 and 18 and Comparative Examples 20 and 21 and passes the above-described quasi-static testing, as also summarized in Table 8.

TABLE 8
Quasi-Static Testing Results

| Sample | Test Result |
|---|---|
| Ex. 16 | Acceptable - Pass |
| Ex. 17 | Acceptable - Pass |
| Ex. 18 | Acceptable - Pass |
| Comp. Ex. 19 | Not acceptable - Fail |
| Comp. Ex. 20 | Acceptable - Pass |
| Comp. Ex. 21 | Acceptable - Pass |

Referring to FIG. 5 and Table 8, each of the components of Examples 16-18 and Comparative Examples 20 and 21 has an acceptable joint strength 36, i.e., a peak load 32 greater than 16 MPa or greater than 3 MPa, respectively. In contrast, the component of Comparative Example 19 does not have an acceptable joint strength 36. Notably, the adhesive compositions of Examples 16-18 include materials B and C, i.e., 2-Ethyl-4-methylimidazole (2,4-EMI) and N-(2-Hydroxyethyl)ethylenediamine (AEEA) and the components of Examples 16-18 have a higher comparative joint strength 36 than the components of Comparative Examples 19-21 even when each adhesive composition is cured at ambient temperature. Therefore, excellent joint strength 36 for components including two sheets of the same or different materials adhered to one another may be obtained by adding materials B and C to material A.

Joint Strength at 82° C.

To prepare the adhesive composition of Examples 22-24, materials A, B, and C are combined in the amounts listed in Table 9.

TABLE 9
Adhesive Compositions

| | | | Mate- | Mate- | Mate- |
|---|---|---|---|---|---|
| | First | Second | rial A | rial B | rial C |
| Sample | Substrate | Substrate | (wt %) | (wt %) | (wt %) |
| Ex. 22 | AA6061 | AA6061 | 93.5 | 4 | 2.5 |
| | aluminum | aluminum | | | |
| Ex. 23 | AA6061 | C_{f}/PA6 | 93.5 | 4 | 2.5 |
| | aluminum | | | | |
| Ex. 24 | C_{f}/PA6 | C_{f}/PA6 | 93.5 | 4 | 2.5 |

The adhesive composition of Comparative Examples 25-27 is a two-component (2K) epoxy adhesive composition commercially available under the trade name Lord® 320 from Lord Corporation of Cary, N.C.

To prepare the components of Example 22 and Comparative Example 25, a plurality of first substrates each formed from aluminum AA6061 and having a thickness of 2 mm, a width of 25 mm, and a length of 100 mm are provided; and a plurality of second substrates formed from aluminum AA6061 and having a thickness of 2 mm, a width of 25 mm, and a length of 100 mm are provided.

To prepare the components of Example 23 and Comparative Example 26, a plurality of first substrates formed from aluminum AA6061 and having a thickness of 2.3 mm, a width of 38 mm and a length of 133 mm are provided; and a plurality of second substrates each formed from a polymeric composite including 30 parts by weight carbon fiber and 70 parts by weight nylon-6 and having a thickness of 2.3 mm, a width of 38 mm, and a length of 133 mm are provided.

To prepare the components of Example 24 and Comparative Example 27, a plurality of first substrates formed from a polymeric composite including 30 parts by weight carbon fiber and 70 parts by weight nylon-6 and having a thickness of 2.3 mm, a width of 38 mm; and a length of 133 mm are provided; and a plurality of second substrates each formed from a polymeric composite including 30 parts by weight carbon fiber and 70 parts by weight nylon-6 and having a thickness of 2.3 mm, a width of 38 mm, and a length of 133 mm are provided.

Each of the plurality of substrates formed from aluminum is pretreated according to the following process to remove any contaminants and/or oxides present on each of the plurality of substrates. Initially, each of the first plurality of substrates is degreased with acetone for 2 minutes in an ultrasonic cleaner to produce a plurality of degreased first substrates. Second, each of the plurality of degreased first substrates is abraded with an 800# abrasive fabric to produce a plurality of abraded first substrates. Next, each of the plurality of abraded first substrates is rinsed with alcohol for 2 minutes in the ultrasonic cleaner to produce a plurality of rinsed first substrates. Then, each of the plurality of rinsed first substrates is immersed for 2 minutes at 70° C. in a solution of 18.54 g of Na₃PO₄.12H₂O, 6.98 g of Na₂SiO₃.9H₂O, 3.0 g of Na₂CO₃, 0.3 g of C₁₈H₂₉SO₃Na, 2.0 g of NaOH, and 200 ml of de-ionized water. After immersing the plurality of rinsed first substrates in solution, each of the plurality of rinsed first substrates is again rinsed thoroughly with de-ionized water for 2 minutes in the ultrasonic cleaner. Next, each of the plurality of rinsed first substrates is dried for 30 minutes at 100° C. to form a plurality of first substrates.

To prepare the components of Examples 22-24 and Comparative Examples 25-27, a respective one of the adhesive compositions of Examples 22-24 and Comparative Examples 25-27 is applied to a respective first substrate with a hand-held injection gun along a bond area at one end of the respective one of the plurality of first substrates. The bond area has a width of 25 mm and a length of 12.5 mm for Example 22 and Comparative Example 25. The bond area has a width of 38 mm and a length of 15 mm for Examples 23 and 24 and Comparative Examples 26 and 27. To avoid the effect of the environment on the surface of each of the plurality of first substrates, the plurality of first substrates are stored in an ambient laboratory environment of 20° C. and 50% relative humidity before the respective one of the adhesive compositions of Examples 22-24 and Comparative Examples 25-27 is applied.

Next, a respective one of the plurality of second substrates is disposed on top of the respective one of the plurality of adhesive compositions of Example 22 and Comparative Example 25 at the bond area so that the second substrate overlaps the first substrate by 12.5 mm to form a plurality of workpieces. A respective one of the plurality of second substrates is disposed on top of the respective one of the plurality of adhesive compositions of Examples 23 and 24 and Comparative Examples 26 and 27 at the bond area so that the second substrate overlaps the first substrate by 15 mm to form a plurality of workpieces. The plurality of workpieces are disposed in a fixture under ambient laboratory conditions. Pressure is applied to the plurality of workpieces through the fixture so that a bondline thickness of the respective adhesive composition is 0.2 mm. Then, each of the plurality of workpieces is cured in an oven for 20 minutes at a temperature of 130° C.

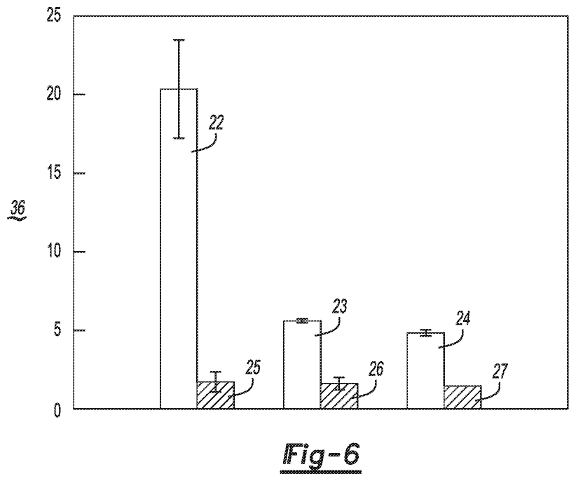

Quasi-static testing is performed on each the components of Examples 22-24 and Comparative Examples 25-27 by loading each of the respective components to failure in a MTS810 tensile tester according to the standard ASTM D1002-2001 to determine a joint strength 36 (FIG. 6) of each of the components. To minimize the bending stresses inherent in such testing, one filler plate is attached to the first substrate of the respective component with masking tape at an end spaced opposite from the bond area, and another filler plate is attached to the second substrate with masking tape at an end spaced opposite from the bond area. Load versus displacement curves are generated as each of the plurality of components is loaded at a stroke rate of 10 mm/minute, and a peak load in each load versus displacement curve is used to evaluate the joint strength 36 (FIG. 6) of the each respective component. Joint strength 36 is defined as a ratio of peak load to an area of the bond area, e.g., 312.5 mm² for Example 22 and Comparative Example 25 and 570 mm² for Examples 23 and 24 and Comparative Examples 26 and 27. Three replicates of the above-described quasi-static testing are performed and an average joint strength 36 at 82° C. for each of the plurality of components of Examples 22-24 and Comparative Examples 25-27 is shown graphically in FIG. 6. A component that has a joint strength 36 of greater than or equal to 16 MPa at 82° C. is acceptable for the components of Example 22 and Comparative Example 25 and passes the above-described quasi-static testing as summarized in Table 10. A component that has a joint strength 36 of greater than or equal to 2 MPa at 82° C. is acceptable for the component of Examples 23 and 24 and Comparative Examples 26 and 27 and passes the above-described quasi-static testing as also summarized in Table 10.

TABLE 10
Quasi-Static Testing Results

| Sample | Test Result |
|---|---|
| Ex. 22 | Acceptable - Pass |
| Ex. 23 | Acceptable - Pass |
| Ex. 24 | Acceptable - Pass |
| Comp. Ex. 25 | Not Acceptable - Fail |
| Comp. Ex. 26 | Acceptable - Pass |
| Comp. Ex. 27 | Acceptable - Pass |

Referring to FIG. 6 and Table 10, each of the components of Examples 22-24 and Comparative Examples 26 and 27 has an acceptable joint strength 36, i.e., a peak load 32 of greater than 16 MPa or greater than 2 MPa, respectively. In contrast, the component of Comparative Example 25 does not have an acceptable joint strength 36. Notably, the adhesive compositions of Examples 22-24 include materials B and C, i.e., 2-Ethyl-4-methylimidazole (2,4-EMI) and N-(2-Hydroxyethyl)ethylenediamine (AEEA) and the components of Examples 22-24 have a higher comparative joint strength 36 than the components of Comparative Examples 26 and 27 even when each adhesive composition is cured at a relatively low temperature of 130° C. Therefore, excellent joint strength 36 for components including two sheets of the same or different materials adhered to one another may be obtained by adding materials B and C to material A.

While the best modes for carrying out the disclosure have been described in detail, those familiar with the art to which this disclosure relates will recognize various alternative designs and embodiments for practicing the disclosure within the scope of the appended claims.

What is claimed is:

1. An adhesive composition comprising:
an epoxy component; and
an additive component reactive with the epoxy component, wherein the additive component comprises:
an imidazole present in an amount of less than or equal to 10 parts by weight based on 100 parts by weight of the adhesive composition; and
an amine present in an amount of less than or equal to 5 parts by weight based on 100 parts by weight of the adhesive composition;
wherein the epoxy component and the additive component are present in the adhesive composition in a ratio of from 1:1 to 15:1.

2. The adhesive composition of claim 1, wherein the imidazole has a number average molecular weight of less than or equal to 115 g/mol.

3. The adhesive composition of claim 1, wherein the imidazole has a melting point of from 36° C. to 42° C.

4. The adhesive composition of claim 1, wherein the imidazole is 2-Ethyl-4-methylimidazole.

5. The adhesive composition of claim 1, wherein the imidazole is present in the adhesive composition in an amount of from 2 parts by weight to 6 parts by weight based on 100 parts by weight of the adhesive composition.

6. The adhesive composition of claim 1, wherein the imidazole is present in the adhesive composition in an amount of from 3 parts by weight to 5 parts by weight based on 100 parts by weight of the adhesive composition.

7. The adhesive composition of claim 1, wherein the amine has a number average molecular weight of less than or equal to 120 g/mol.

8. The adhesive composition of claim 1, wherein the amine has a melting point of from −30° C. to −25° C.

9. The adhesive composition of claim 1, wherein the amine is N-(2-Hydroxyethyl)ethylenediamene.

10. The adhesive composition of claim 1, wherein the amine is present in the adhesive composition in an amount of from 1 part by weight to 4 parts by weight based on 100 parts by weight of the adhesive composition.

11. The adhesive composition of claim 1, wherein the amine is present in the adhesive composition in an amount of from 2 parts by weight to 3 parts by weight based on 100 parts by weight of the adhesive composition.

12. The adhesive composition of claim 1, wherein the epoxy component comprises a heat-curable epoxy resin.

13. The adhesive composition of claim 1, wherein the epoxy component comprises:
epichlorohydrin-4,4′-isopropylidene diphenol resin present in an amount of from 30 parts by weight to 60 parts by weight based on 100 parts by weight of the epoxy component;
bisphenol A diglycidyl ether resin present in an amount of from 10 parts by weight to 30 parts by weight based on 100 parts by weight of the epoxy component;
fumed silica present in an amount of from 1 part by weight to 5 parts by weight based on 100 parts by weight of the epoxy component;
tris(methylphenyl) phosphate present in an amount of from 1 part by weight to 5 parts by weight based on 100 parts by weight of the epoxy component; and
calcium oxide present in an amount of from 1 part by weight to 5 parts by weight based on 100 parts by weight of the epoxy component.

14. A component comprising:
a first substrate formed from a first material;
a second substrate formed from a second material and overlapping and adhered to the first substrate at a bond area; and
a cured adhesive formed from an adhesive composition and disposed between and in contact with the first substrate and the second substrate at the bond area;
wherein the adhesive composition comprises:
an epoxy component; and
an additive component reactive with the epoxy component, wherein the additive component comprises:
an imidazole present in an amount of less than or equal to 10 parts by weight based on 100 parts by weight of the adhesive composition; and
an amine present in an amount of less than or equal to 5 parts by weight based on 100 parts by weight of the adhesive composition;
wherein the epoxy component and the additive component are present in the adhesive composition in a ratio of from 1:1 to 15:1.

15. The component of claim 14, wherein the first material is different from the second material.

16. The component of claim 15, wherein the first material has a first coefficient of thermal expansion and the second material has a second coefficient of thermal expansion that is less than the first coefficient of thermal expansion; and
further wherein the first material and the second material are free from distortion at the bond area.

17. The component of claim 14, wherein the first material is the same as the second material.

18. The component of claim 14, wherein the amine is N-(2-Hydroxyethyl)ethylenediamene and is present in an amount of from 1 part by weight to 3 parts by weight based on 100 parts by weight of the adhesive composition; and
further wherein the imidazole is 2-Ethyl-4-methylimidazole and is present in an amount of from 3 parts by weight to 5 parts by weight based on 100 parts by weight of the adhesive composition.

19. A method of forming a component, the method comprising:
applying an adhesive composition to a first substrate at a bond area, wherein the adhesive composition comprises:
an epoxy component; and
an additive component reactive with the epoxy component, wherein the additive component comprises:
an imidazole present in an amount of less than or equal to 10 parts by weight based on 100 parts by weight of the adhesive composition; and
an amine present in an amount of less than or equal to 5 parts by weight based on 100 parts by weight of the adhesive composition;
wherein the epoxy component and the additive component are present in the adhesive composition in a ratio of from 1:1 to 15:1;
disposing a second substrate onto the adhesive composition at the bond area;
pressing together the first substrate, the adhesive composition, and the second substrate at the bond area; and
curing the adhesive composition at a temperature of less than or equal to 150° C. for less than or equal to 30 minutes to thereby join the first substrate and the second substrate and form the component.

20. The method of claim 19, wherein curing includes heating the adhesive composition at a temperature of less than or equal to 130° C. for less than or equal to 20 minutes.
